(19) United States
(12) Patent Application Publication
(10) Pub. No.: US 2008/0123887 A1
(43) Pub. Date: May 29, 2008

(54) Absorption of electromagnetic radiation in hearing apparatuses

(76) Inventors: Markus Heerlein, Singapore (SG); Thomas Kasztelan, Erlangen (DE); Bock Swee Joshua Tan, Singapore (SG)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/973,248

(22) Filed: Oct. 5, 2007

(30) Foreign Application Priority Data
Sep. 10, 2006 (DE) 102006047691.3

(51) Int. Cl. H04R 25/00

(52) U.S. Cl. 381/324; 381/312; 977/742

(57) ABSTRACT

The electromagnetic compatibility of hearing apparatuses and in particular hearing devices is to be improved. To this end, provision is made to use a plastic-based absorbent material with metal particles in the hearing apparatus. The absorbent material absorbs the electromagnetic radiation and converts it into heat. In particular, mounting elements for microphones and receivers can be produced from the absorbent material. This multiple functionality results in additional space savings.

### CROSS REFERENCE TO RELATED APPLICATIONS

This application claims priority of German application No. 102006047691.3 DE filed Oct. 9, 2006, which is incorporated by reference herein in its entirety.

### FIELD OF INVENTION

The present invention relates to using an absorbent material for absorbing electromagnetic radiation in/on a hearing apparatus. Furthermore, the present invention relates to a corresponding hearing apparatus. The term hearing apparatus is understood here to mean any type of portable or non-portable acoustic device, in particular a hearing device, headset or earphones.

### BACKGROUND OF INVENTION

Hearing devices are portable hearing apparatuses which are used to supply the hard-of-hearing. To accommodate the numerous individual requirements, different configurations of hearing devices such as behind-the-ear hearing devices (BTE), in-the-ear hearing devices (ITE), and concha hearing devices, are provided. The hearing devices mentioned by way of example are worn on the outer ear or in the auditory canal. Furthermore, bone conduction hearing aids, implantable or vibrotactile hearing aids are also available on the market. The damaged hearing is herewith either stimulated mechanically or electrically.

Essential components of the hearing devices include in principal an input converter, an amplifier and an output converter. The input converter is generally a receiving transducer, e.g. a microphone and/or an electromagnetic receiver, e.g. an induction coil. The output converter is mostly realized as an electroacoustic converter, e.g. a miniature loudspeaker, or as an electromechanical converter, e.g. a bone conduction receiver. The amplifier is usually integrated into a signal processing unit. This main configuration is shown in the example in FIG. 1 of a behind-the-ear hearing device. One or a number of microphones 2 for recording the ambient sound are incorporated in a hearing device housing 1 to be worn behind the ear. A signal processing unit 3, which is similarly integrated into the hearing device housing 1, processes the microphone signals and amplifies them. The output signal of the signal processing unit 3 is transmitted to a loudspeaker and/or receiver 4, which outputs an acoustic signal. The sound is optionally transmitted to the ear drum of the device wearer via a sound tube, which is fixed with an otoplastic in the auditory canal. The power supply of the hearing device and in particular of the signal processing unit 3 is provided by a battery 5 which is likewise integrated into the hearing device housing 1.

Hearing devices, both BTEs and ITEs, are frequently exposed to high cellular radio field strengths, thereby frequently resulting in acoustic interferences. The electromagnetic fields produced by automotive electronics systems can also cause interferences in hearing devices.

In order to shield electromagnetic radiation, the plastic shells of hearing devices are thus gilded for instance. In this context, patent application DE 196 35 229 C2 describes a direction-sensitive hearing aid, with which the hearing device housing halves are provided with a radiation-shielding material, in particular a metallization, in order to prevent a disadvantageous effect caused by interference fields produced by cellular telephones for instance. The shielding is preferably located on the interior of the hearing device housing halves and is thus protected against mechanical influences. The metallization can however result in environmental problems in terms of recycling hearing devices.

Special EMC microphones are also used to improve the electromagnetic compatibility (EMC) of a hearing device. Optical microphones, which neither produce electromagnetic interferences nor are negatively affected by electromagnetic fields are particularly worth mentioning here.

Materials which attenuate the transmission of electromagnetic radiation and were recently provided by the company ARC (www.arc-tech.com) are used to shield electromagnetic radiation. In this connection, the electromagnetic radiation is absorbed and converted into heat. This basically represents a different solution to that of metal coating, whereby the interfering electromagnetic radiation is reflected.

A plastic by the name of naturalnano® is known as a further shielding material for electromagnetic radiation, said plastic being provided with nano tubes, which are coated or filled with copper for instance. This material is available as wall paint for instance, thereby allowing rooms to be electromagnetically shielded.

### SUMMARY OF INVENTION

The object of the present invention consists in reducing the sensitivity of hearing devices to electromagnetic fields.

In accordance with the invention, this object is achieved by the use of an absorbent material for absorbing electromagnetic radiation in/on a hearing apparatus, with the absorbent material being plastic-based and comprising metal particles.

Furthermore, provision is made in accordance with the invention for a hearing apparatus with an electronics component and an absorber for absorbing electromagnetic radiation, which at least partially surrounds the electronics component, with the absorber being plastic-based and comprising metal particles.

It is thus advantageously possible to dispense with an expensive gilding of the hearing device housing or a hearing device component for instance. In this way, environmental problems in terms of recycling are also avoided since no plastics with metal coatings are used.

The absorbent material is preferably used for a casing of a receiver, a microphone and/or an electrical conductor of the hearing apparatus. Electromagnetic fields and/or the corresponding electromagnetic radiation are thus attenuated precisely at those components of a hearing device at which there is danger of electromagnetic interaction.

It is particularly advantageous to use the absorbent material to mount a receiver and/or microphone. The mounting thus achieves an additional EMC protective function.

The absorbent material can be a conductive polyester. A very robust absorbent material thus results on the basis of the positive characteristics of the polyester.

Furthermore, the absorbent material can be provided with metal-filled or metal-coated nano tubes. High absorption levels can thus be achieved in some frequency ranges.

As already mentioned, the said electronics component of the hearing apparatus can be a receiver, a microphone or an electronic conductor for instance. In particular, the receiver and the microphone are to be mounted in a hearing device shell in an attenuating fashion in order to avoid crosstalk through the body shell. It is thus particularly advantageous to simultaneously use the inserted mounting elements for electromagnetic shielding and to thus create them from the corresponding absorbent material.

According to a special embodiment, the absorber is designed as a film which is wrapped around the electronics component. The advantage of a film is that it can be easily applied and also requires little space.

The absorber can however also be realized as a deep-drawn shell or capsule for the electronics component. In this way, it can in turn adopt the functionality of a bracket.

### BRIEF DESCRIPTION OF THE DRAWINGS

The present invention is described in more detail with reference to the appended drawings, in which:

FIG. 1 shows a schematic diagram of a hearing device with its essentially electronic components;

FIG. 2 shows a cut-out of a hearing device with a shielding of the microphones and the receiver according to a first embodiment of the present invention;

FIG. 3 shows a shielding of the microphones and the receiver according to a second embodiment of the present invention;

FIG. 4 shows a shielding of a receiver according to a third embodiment of the present invention, and

FIG. 5 shows a shielding of microphones according to a fourth embodiment of the present invention.

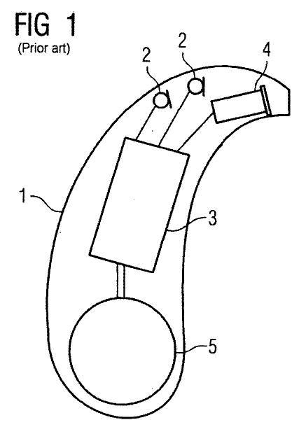

### DETAILED DESCRIPTION OF INVENTION

The exemplary embodiments illustrated in more detail below represent preferred embodiments of the present invention.

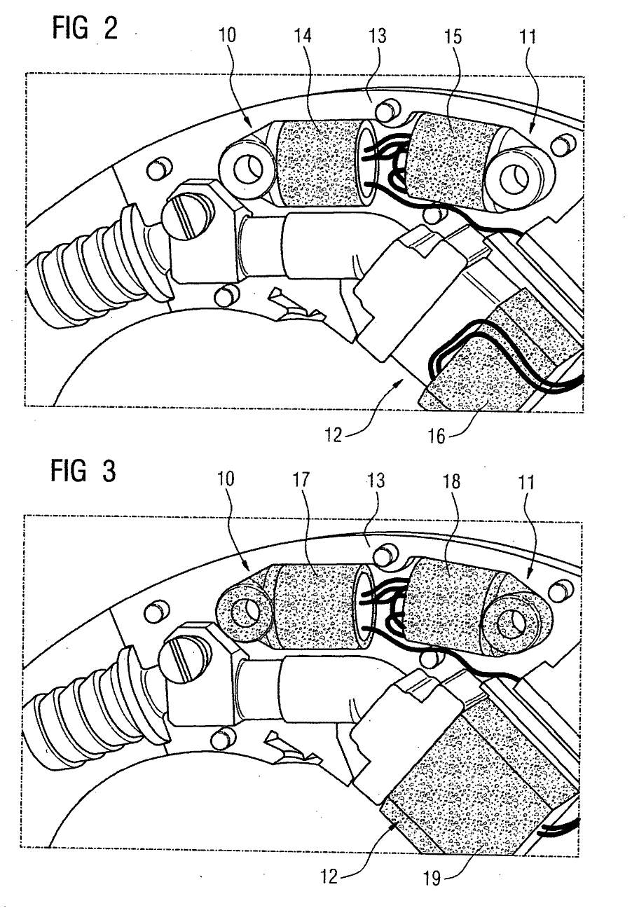

FIG. 2 shows the view into a BTE, in which a housing half shell is removed. In particular, the cut-out of the hearing device is shown, which indicates two microphones 10, 11 and a receiver 12. These components are inserted into corresponding recesses of the hearing device housing 13, but are not rigidly connected to the hearing device housing 13, but instead are mounted in the housing 13 with a rubber-like material. The microphones 10 and 11 are thus surrounded by a tubular, rubber-like bracket 14, 15. The receiver 12 is also surrounded on its periphery with a correspondingly dimensioned, rubber-like and tubular bracket 16. The brackets 14, 15 and 16 consist of an absorbent material for absorbing electromagnetic radiation, i.e. for shielding corresponding electromagnetic fields. The electromagnetic radiation is thus not reflected, but instead absorbed, so that electronics components from the environment are not additionally adversely affected by reflected electromagnetic radiation.

The brackets 14, 15 and 16 can consist of rubber or rubber-like plastic, to which is added a corresponding absorbent material. The absorbent material can comprise metal particles or metal-coated and/or metal-filled nano tubes for instance. Copper is particularly suited to the coating and/or filler.

According to the example in FIG. 2, the brackets 14, 15 and 16 completely surround the periphery of the microphones 10, 11 and the receiver 12. It is however also possible to design the brackets such that they support the components to be mounted in a purely punctiform fashion. In this case, a bracket can consist of two, three, four etc. individual components for instance.

FIG. 3 shows a second embodiment of the present invention, with which the microphones 10, 11 are completely surrounded with a casing 17, 18. These casings 17, 18 are in turn produced from the said absorbent material. They protect the entire exterior surface of the microphones from electromagnetic radiation and/or electromagnetic fields. As the casings 17, 18 completely surround the microphones 10, 11, they also simultaneously function as vibration-isolating brackets.

In this example, the receiver 12 is wrapped with an absorbing film 19. The film 19 protects a large part of the shell of the receiver 12. The front sides and a part of the shell of the receiver 12 are not protected here against elecromagnetic radiation. Here the film can also adopt the functionality of a bracket. It can do this the thicker it is, or the more often it is wrapped around the receiver 12.

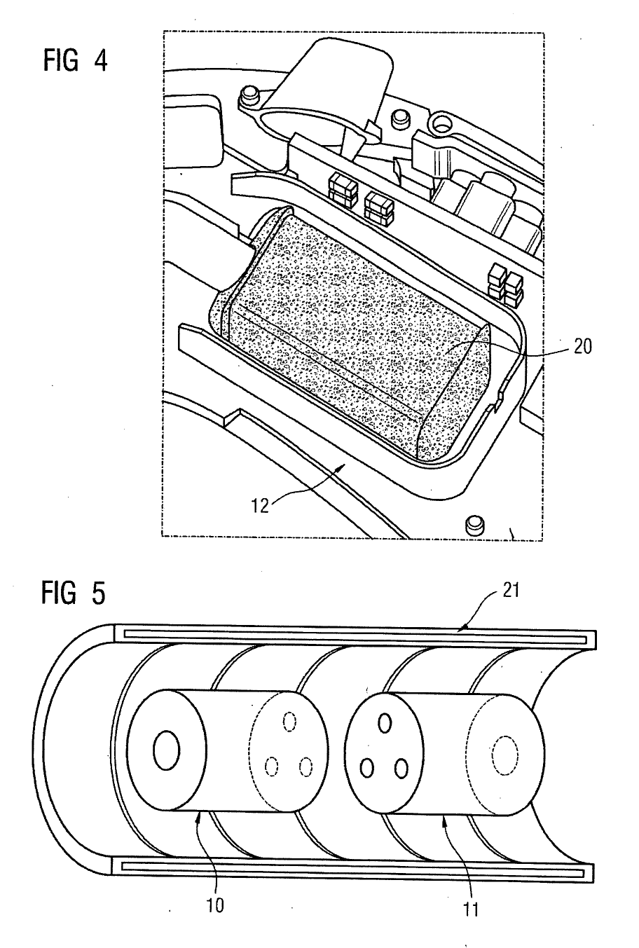

A third embodiment of a hearing device according to the invention is shown in parts in FIG. 4. A receiver 12, which is embedded in a capsule 20, is essentially shown here in a concrete fashion. This capsule 20 almost completely surrounds the receiver 12, as was also shown in the examples of the microphones 10 and 11 in FIG. 3. In contrast to the embodiment in FIG. 3, the receiver 12 is thus completely surrounded here with an EMC protection, since the capsule 20 is likewise provided here with the absorbent material, and/or is formed therefrom. As already the case with the preceding exemplary embodiments, the capsule 20 also adopts the function of a bracket.

A fourth embodiment of the present invention is shown schematically in FIG. 5. This only shows how the microphones 10, 11 are shielded by a half capsule 21. The half capsule 21 consists in turn of an EMC absorbent material. According to this exemplary embodiment, it is sufficient to shield the microphones 10, 11 against electromagnetic interferences in one direction. A second half shell can optionally be used in order to achieve inherent protection in all radial directions.

The exemplary embodiments illustrated above show that the brackets of the receivers and/or microphones can simultaneously advantageously adopt an EMC protection function. This is further advantageous in that inexpensive microphones without special EMC protection can be used in hearing apparatuses and hearing devices. The price of hearing devices can herewith be reduced, for example.

The multiple functionality of the brackets also saves on space. In particular, the afore-mentioned absorbing film also only has a minimal space requirement.

Space savings also result in that no so-called “Ferrite Beads” are necessary on the amplifiers as a result of the EMC shielding by the absorbent material. These Ferrite Beads are inductors, which enable electromagnetic interferences to be compensated. These nevertheless exhibit a significant space requirement.

In the event that an electronics component is completely surrounded with the absorbent material, the outcome is not only a complete EMC protection but, in some circumstances, also improved splash water resistance.

It remains open to the designer to combine the individual embodiments of the absorber, such as films, capsules, bracket elements, tubes etc. with one another and with metal coatings or metals for further reflective shielding purposes.

1.-11. (canceled)

12. A hearing apparatus, comprising:
an absorbent material for absorbing electromagnetic radiation, the material being plastic-based and the material includes metal-filled or metal-coated nano tubes.

13. The hearing aid as claimed in claim 12, wherein the material is used to mount at least a receiver or a microphone of the hearing aid.

14. The hearing aid as claimed in claim 13, wherein the material is a conductive polyester.

15. The hearing aid as claimed in claim 12, wherein the material is used for a casing for at least a receiver, a microphone, or an electrical conductor of the hearing aid.

16. The hearing aid as claimed in claim 15, wherein the material is used to mount at least the receiver or the microphone.

17. The hearing aid as claimed in claim 16, wherein the material is a conductive polyester.

18. A hearing aid apparatus, comprising:
an electronics component; and
an absorbent material that absorbs electromagnetic radiation and is used to mount the component,
wherein the material is formed from a rubber or a rubber-like plastic and the material comprises metal particles.

19. The hearing apparatus as claimed in claim 18, wherein the electronics component is a receiver, a microphone or an electrical conductor.

20. The hearing apparatus as claimed in claim 18, wherein material at least partially surrounds the electronics component.

21. A hearing apparatus, comprising:
an electronics component; and
an absorber for absorbing electromagnetic radiation and which at least partially surrounds the electronics component,
wherein the absorber is plastic-based and includes metal-filled or metal-coated nano tubes.

22. The hearing apparatus as claimed in claim 21, wherein the electronics component is a receiver, a microphone or an electrical conductor.

23. The hearing apparatus as claimed in claim 21, wherein the absorber being designed as a mounting element for the electronics component.

24. The hearing apparatus as claimed in claim 21, wherein the absorber being a film wrapped around the electronics component.

25. The hearing apparatus as claimed in claim 21, wherein the absorber comprising a deep-drawn shell or a capsule for the electronics component.
